(19) United States
(12) Patent Application Publication
(10) Pub. No.: US 2020/0064869 A1
(43) Pub. Date: Feb. 27, 2020

(54) PERPETUAL UNMANNED AERIAL VEHICLE SURVEILLANCE

(71) Applicant: Hewlett Packard Enterprise Development LP, Houston, TX (US)

(72) Inventor: Seth Pickett, Fort Collins, CO (US)

(21) Appl. No.: 16/108,459

(22) Filed: Aug. 22, 2018

(51) Int. Cl. G05D 1/10; H04N 7/18; G05D 1/00; G05D 1/02; B64C 39/02

(52) U.S. Cl. CPC G05D 1/104; H04N 7/181; G05D 1/0088; G05D 1/0225; B64C 2201/146; G05D 1/0094; B64C 39/024; B64C 2201/127; B64C 2201/141; G05D 1/0011

(57) ABSTRACT

In some examples, a method of perpetual unmanned aerial vehicle (UAV) surveillance includes positioning a first UAV at a first vantage point at which the first UAV has a first field of view; causing the first UAV to move from the first vantage point towards a second vantage point at which the first UAV has a second field of view; and responsive to the first UAV moving towards the second vantage point, positioning a second UAV at the first vantage point to perpetually surveille the first field of view.

### BACKGROUND

An unmanned aerial vehicle (UAV) (also referred to as a “drone”) is an aircraft that operates without a human pilot aboard the UAV. A UAV may be included in an unmanned aircraft system (UAS). A UAS may include a UAV, a controller such as a ground-based controller, and a system of communications between the UAV and the controller. A UAV may operate under remote control by a human operator or autonomously under control of a computer such as a computer onboard the UAV. The UAV can include an imaging system including a camera to perform surveillance. For instance, the UAV can perform surveillance while airborne.

### BRIEF DESCRIPTION OF THE DRAWINGS

FIG. 1A is an example of a system for perpetual unmanned aerial vehicle (UAV) surveillance consistent with the present disclosure.

FIG. 1B is an example of a system for perpetual UAV surveillance consistent with the present disclosure.

FIG. 1C is an example of a system for perpetual UAV surveillance consistent with the present disclosure.

FIG. 2 is a block diagram of an example of another system for perpetual UAV surveillance consistent with the disclosure.

FIG. 3 is another example of a system including UAV docking station for perpetual UAV surveillance consistent with the disclosure.

FIG. 4 illustrates an example of a method consistent with the disclosure.

### DETAILED DESCRIPTION

Objects and/or areas, such as factory complexes, building complexes, buildings, and industrial complexes, can be surveyed using video surveillance systems. For instance, some approaches may employ video surveillance systems involving static cameras. However, such cameras may be limited to surveillance of static areas in range of the static camera as the camera may not be readily repositioned at a different geographic location. Other approaches may employ mobile cameras such as a camera included in an unmanned aerial vehicle (UAV). However, a UAV may include a battery with a finite amount of power. Operation of the UAV, such as operation of a camera and/or operation of rotors, to cause the UAV to fly may consume and exhaust power from the battery embedded in the UAV. Consequently, the UAV may have a limited amount of time during which the UAV can perform various operations such as surveillance while the UAV is flying. For instance, the UAV may cease surveillance while flying to instead move to a docking station that is fixed on the ground and/or recharge a battery at the docking station.

As such, the disclosure is directed to perpetual UAV surveillance. For instance, UAVs can perform surveillance at a first vantage point (e.g., an aerial vantage point) and a second vantage point (e.g., at a docking station) so the first vantage point and/or the second vantage point each has perpetual UAV surveillance.

As used herein, “perpetual UAV surveillance” and “perpetually surveille” refers to surveillance provide by a plurality of UAVs that together are positioned to provide continuous or near continuous surveillance at a vantage point such as a first vantage point. As used herein, “continuous surveillance” refers a UAV being positioned at a vantage point for an entirety of a time period. For instance, over a 24 hour time period, a UAV is positioned at a vantage point for 24 hours. As used herein, “near continuous surveillance” refers to a UAV being positioned at a vantage point for a threshold percentage of a given time period. For instance, over a 24 hour time period, a UAV can be positioned at a vantage point for 22.8 hours when the threshold percentage is 95%. The threshold percentage can vary. For instance, the threshold percentage can be a value in the range of values extending from 5% to 100% of a 24 hour time period or different time period. For instance, the threshold percentage can be 5%, 10%, 20%, 30%, 40%, 50%, 60%, 70%, 80%, or 90% of a time period, among other possible values.

As mentioned, a plurality of UAVs such as a first UAV and a second UAV can together provide perpetual UAV surveillance. That is, the second UAV is a different device than the first UAV, providing for a total number of to two different devices can provide perpetual UAV surveillance by moving independent of each other (e.g., moving in different direction and/or being at different locations at the same time). However, it is understood that a total number of the UAVs employed to provide perpetual UAV surveillance can be increased, for instance to three, four, fifty, or hundreds of UAVs, among other possibilities.

Moreover, it is noted that while the UAV can provide continuous monitoring while positioned at a vantage point, the UAV can in some examples perform monitoring over a portion of but not all of an amount of time while physically present at the vantage point. Further, in other examples, the UAV can perform no monitoring during an amount of time present at the vantage point and still be understood to provide perpetual UAV surveillance due to being positioned to provide continuous or near continuous surveillance of an area when monitoring is requested by a user or otherwise. That is, as used herein, “monitoring” refers to the active gathering of information related to an object or area. For instance, in some examples, perpetual UAV surveillance can include providing continuous monitoring (e.g., video and/or audio surveillance) of a vantage point by a UAV (e.g., a video and/or audio sensor, a RFID sensor, a location/beacon sensor, etc.).

Notably, perpetual UAV surveillance can be performed for a wide range of geographic locations, in contrast to other approaches such as those that employ static cameras at a location. That is, in some examples, a UAV's flight pattern could be re-programmed (e.g., by an operator or a controller), for instance, to focus on different locals of interest, take a different flight path to and/or from areas of interest, etc. Moreover, while at the second vantage point, a UAV can provide surveillance from the second vantage point, as detailed herein.

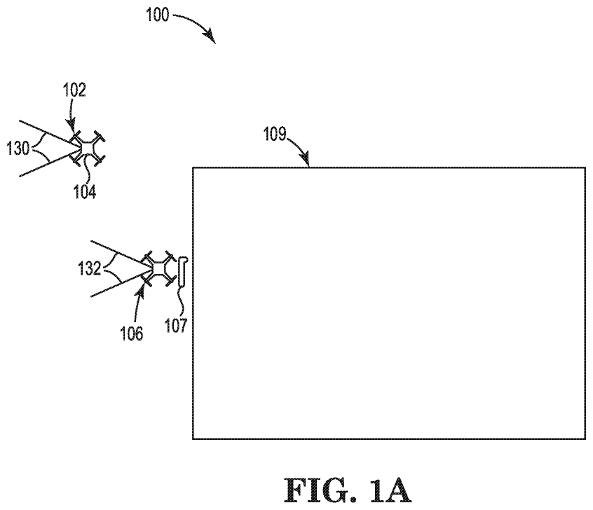

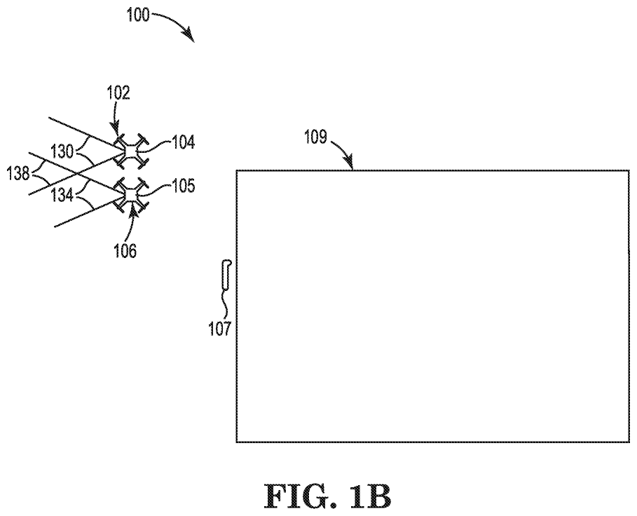

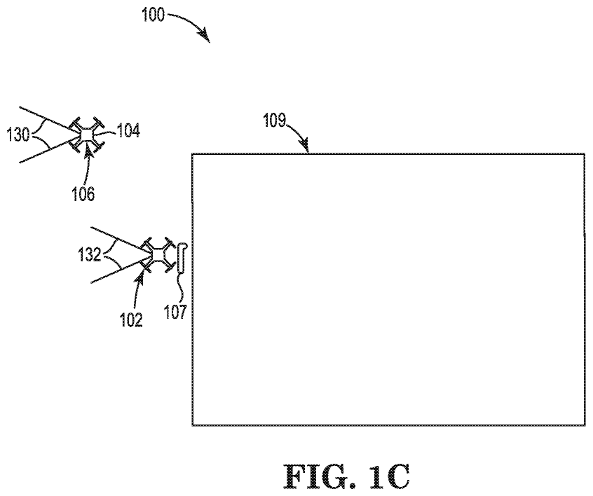

FIG. 1A is an example of a system 100 for perpetual UAV surveillance consistent with the present disclosure. As illustrated in FIG. 1, the system 100 can include a first UAV 102 and a second UAV 106. As used herein, a “UAV” as used herein refers to an aircraft that does not have a human pilot on board, and whose flight is controlled autonomously by an on-board computing system and/or by a human or computer via remote control. A UAV can navigate (e.g., autonomously using geographic information system (GIS) coordinates) to a location such as vantage point and capture images or other information of the location.

The first UAV 102 and/or the second UVA 106 can include a camera, microphone, and/or other equipment to capture information. The captured images and/or other information can be transmitted, via a network, to a remotely located computing device in a wired and/or wireless manner. The captured information can also be stored in a storage in the UAV and transmitted to the computing device later after a period of continuous surveillance time. For instance, a UAV can include a processing resource, memory, and/or input/output interfaces, including wired network interfaces such as institute of electrical and electronics engineers (IEEE) 802.3 Ethernet interfaces, as well as wireless network interfaces such as IEEE 802.11 Wi-Fi interfaces, although examples of the disclosure are not limited to such interfaces.

A UAV can include a memory resource, including read-write memory, and a hierarchy of persistent memory such as read-only memory (ROM), electrically programmable read only memories (EPROM), and Flash memory. The network can be a wireless network, for example, a wireless local area network (WLAN). As used herein, WLAN can, for example, refer to a communications network that links two or more devices using some wireless distribution method (for example, spread-spectrum or orthogonal frequency-division multiplexing radio), and usually providing a connection through an access point (AP) to the Internet; and thus, providing users with the mobility to move around within a local coverage area and still stay connected to the network.

As illustrated in FIG. 1, the first UAV 102 can be positioned at a first vantage point 104. Similarly, the second UAV 106 can be positioned at a second vantage point 107. As used herein, “a vantage point” refers to a geographic location. The geographic location can be an absolute geographic location defined by a longitude and a latitude, among other possibilities. The geographic location may also include a relative geographic location (e.g., distance and/or direction relative to a known object) and a height (which can be an absolute elevation from sea level or a relative height from the ground level). Examples of vantage points include an aerial location (i.e., a location of a UAV while a UAV is flying) and/or surface location when the UAV is grounded (i.e., not in-flight).

For instance, as illustrated in FIG. 1, the first vantage point 104 can be an aerial location at which the first UAV 102 is airborne, while the second vantage point 107 can be a surface location at which the second UAV is grounded. In such examples, the second UAV 106 can be docked in a UAV docking station, as detailed herein, when at the second vantage point 107. As illustrated in FIG. 1, the second vantage point 107 can be docking station located proximate to a structure 109 such as a factory complexes, building complex, a building, and/or other type of complexes/buildings occupying a geographic area. The structure 109 can include a remotely located computing device, as described herein.

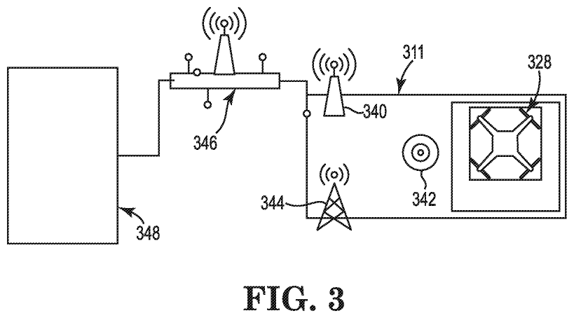

However, the disclosure is not so limited. Rather, a location and/or type of the first vantage point 104 and/or the second vantage point 107 can be varied. For instance, in some examples, first vantage point 104 can be a surface location while the second vantage point 107 can be aerial vantage point. That is, the first vantage point, the second vantage point, or both the first vantage point and the second vantage point can be a static location such as UAV docking station or other fixed location. As used herein a “static location” refers to a fixed location of a physical structure such as a UAV docking station. In some examples, the first UAV 102 and/or the second UAV 106 can communicate information when docked at a UAV docking station, among other possibilities. For instance, in some examples, the first vantage point 104 and/or the second vantage point can be at a UAV docking station, such as a UAV docking station as described in greater detail with respect to FIG. 3.

In some examples, the first vantage point and/or the second vantage point can form a portion of a flight path of a UAV. For instance, in some examples, both the first vantage point and the second vantage point further comprises a plurality of locations together forming a flight path. As used herein, a “flight path” refers to an actual or a planned course of a UAV. In such examples, the vantage point can be a part of the flight path can be considered a dynamic location as it can be without structure (e.g., a geolocation while a UAV is flight). The dynamic location (and/or a particular static location included in a flight path) can be readily changed depending upon an object/area of interest for perpetual surveillance. For instance, a flight path and therefore a vantage point (e.g., a first vantage point) can be changed and the changed location (e.g., a different geolocation) can be provided to a UAV such as when the UAV is docked in a docking station or otherwise provided to the UAV.

When at the first vantage point 104 the first UAV 102 can have a first field of view (represented by lines 130), while when at the second vantage point 107 the first UAV 102 can have a second field of view (represented by lines 132). As illustrated in FIG. 1B, the second vantage point 107 has a different scope/area than a scope/area of the first vantage point 104. Similarly, when at the first vantage point 105 the second UAV 106 can have the first field of view 134, while when at the second vantage point 107 the second UAV 106 can have the second field of view 132. That is, as detailed herein UAVs can be positioned in a manner to provide perceptual surveillance of a vantage point.

In various examples, the first UAV 102 can be positioned at the first vantage point 104 at which the first UAV 102 has the first field of view 130. As used herein, being “positioned” at a vantage point refers to being physical present at a geographic location.

For instance, the first UAV can be positioned at the first vantage point responsive to a user input (e.g., provided to remote control associated with the first UAV 102) and/or in accordance with a preprogrammed flight schedule of the first UAV 102, among other possibilities, to cause the first UAV to move towards the first vantage point. As used herein, “move to” and/or “moving towards” a vantage point refers to changing a geographic location of a UAV to a different geographic location that is closer to or located at the vantage point. For instance, a UAV can follow a programmed flight path and/or respond to a user input to move towards a vantage point such as first vantage point 104.

Movement towards a vantage point can initiate from a different vantage point a UAV is located at, from a location of a user having a UAV, and/or from a UAV docking station at which the UAV is docked, among other possibilities. The first UAV 102 can be positioned at the first vantage point 104 in an “on demand” manner based on a user input and/or based on a preprogrammed flight schedule such as schedule associated with periodic monitoring of the first vantage point, among other possibilities.

In various examples, the first UAV 102 can be caused to move from the first vantage point 104 towards the second vantage point 107 at which the first UAV 102 has the second field of view 132, which may be the same or similar to the second field of view 132 of the second UAV 106 when the second UAV is at the second vantage point 107. In some examples, the first UAV 102 can be caused to move from the first vantage point 104 to the second vantage point responsive to a battery level of the first UAV reaching a base battery level (i.e., a low battery state). The base battery level (i.e., a “low” battery level) refers to a predetermined amount or percentage remaining (e.g., 10%) of a total battery power capacity (e.g., 100%) of a UAV that is not charging. The base battery level can be determined while a UAV is in flight (not charging). The base battery level can be a numerical value or percentage from 90% to 1% of a total battery capacity of a UAV. In this manner, the first UAV 102 can proceed to the second vantage point 107 and/or other location with a UAV docking station to recharge the battery of the first UAV 102 before the first UAV 102 reaches a critical or zero battery level. However, the disclosure is not so limited.

For instance, the first UAV 102 can move towards the second vantage point 107 responsive to a battery level of the second UAV 106 reaching a threshold battery level, a predetermined period of time elapsing at the first vantage point, and/or responsive to a user input. The threshold battery level (i.e., a “charged” battery level) refers to a predetermined amount or percentage (e.g., 85%) of a total battery capacity (e.g., 100%). The threshold battery level can be determined while a UAV is charging such as charging at a docking station. The threshold battery level can be a numerical value or percentage from 100% to 20% of a total battery capacity of a UAV.

As mentioned, in some examples the first UAV 102 can move toward the second vantage point 107 responsive to a predetermined period of time elapsing at the first vantage point 104. For instance, the first UAV 102 can move from the first vantage point 104 following a predetermined period of time (e.g., 30 minutes or other amount of time) elapsing at the first vantage point that is part of a preprogrammed flight schedule of the first UAV 102.

As mentioned, in some examples the first UAV 102 can move toward the second vantage point 107 responsive to a user input. As user input can be provided via a remote control of the first UAV 102 or otherwise provided to the first UAV 102.

FIG. 1B is an example of a system 100 for perpetual UAV surveillance consistent with the present disclosure. As illustrated in FIG. 1B, responsive to the first UAV 102 moving towards the second vantage point 107, the second UAV 106 can move towards the first vantage point 104 to a third vantage point 105 to perpetually surveille the first field of view 130. That is, as illustrated in FIG. 1B, the first field of view 130 when at the first vantage point and the third field of view 134 when at the third vantage point 105 can include an overlapping portion 138 (i.e., overlapping fields of view) that is monitored, for a period of time, by each of the first UAV 102 and the second UAV 106, respectively. The overlapping portion refers to an area in the respective fields of view a plurality of UAVs. A size/relative location etc. of the overlapping portion 138 can be varied. In this manner, the first UAV 102 and the second UAV 106 can provide for perpetual surveillance of the overlapping portion of fields of view 138 to is monitored without a break in surveillance between the first UAV and the second UAV.

However, the disclosure is not so limited. Rather, the first UAV 102 and the second UAV 106 can together provide surveillance at a vantage point such as the first vantage point 104 sequentially without an overlapping portion of fields of view. For instance, the first UAV 102 can move a distance away from the first vantage point 104 (e.g., towards the second vantage point 107) such the first UAV 102 no longer has the first field of view 130, and the second UAV 106 can be subsequently positioned at the first vantage point 104 with the first field of view 130.

FIG. 1C is an example of a system 100 for perpetual UAV surveillance consistent with the present disclosure. As mentioned, the second UAV 106 can be positioned at the first vantage point 104, either with an overlapping field of view (as illustrated in FIG. 1B) or sequentially to perpetually surveille the first field of view 104. That is, the first UAV 102 and the second UAV 106 can together surveille some or all of the field of view such as the first field of view 130 from the first vantage point 104.

In some examples, the first UAV 102 and the second UAV 106 can surveille the exact same field of view at different time, however, it is understood that they can surveille some or all of the same field of view at different time. For instance, if an object in interest (e.g., a person, vehicle, or other object) in the field of view 130 moves within (or outside of) a field of view of the first UAV 102 then the second UAV can adjust a direction of the first field of view 130 to center (along a give axis or plurality of axes) or otherwise orient the object within a first field of view of the second UAV 106 to promote perpetual UAV surveillance, as described herein. Similarly, if an object moves within a field of view of a UAV such as the first UAV 102 then the UAV can move/or change an orientation of a sensor such as camera (along a give axis or plurality of axes) to ensure the object of interest remains in the field of view of the UAV. For instance, a UAV can speed and/or direction match with an object to remain a given fixed distance from the object at a dynamic series of locations while another UAV (e.g., a second UAV) can move toward a most recent location in the dynamic series of location to permit switching with the UAV and maintaining perpetual surveillance of the object. In this manner, even moving objects can be perpetually surveilled.

As illustrated in FIG. 1C, in some examples the first UAV 102 can be docked in a UAV docking station when at the second vantage point 107. However, the disclosure is not so limited. For instance, in some examples, the first UAV can be at a surface location such as docked in a UAV docking station when at the first vantage point 107, while the first UAV can be at an aerial location when at the second vantage point 104.

In some examples, the first UAV 102 can resume position at the first vantage point 104 similar to same to the position of the first UAV as illustrated in FIG. 1A. For instance, the first UAV 102 can resume position at the first vantage point 104 responsive to the second UAV 106 moving away from the first vantage point 104. As used herein, “moving away from” a vantage point refers to changing a geographic location of a UAV to a different geographic location that is not located at or further way from the vantage point.

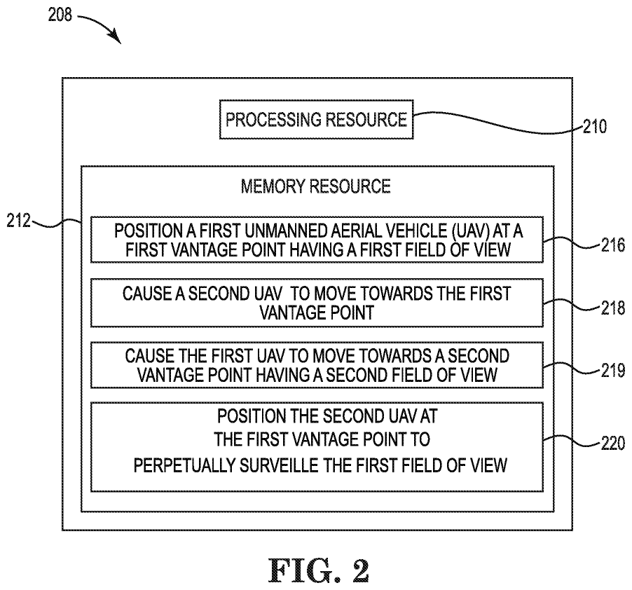

FIG. 2 is a block diagram of an example of another system 208 for perpetual UAV surveillance consistent with the disclosure. As described herein, a UAV (e.g., first UAV 102 and/or second UAV 106, described in connection with FIG. 1) be employed for perpetual surveillance. Although the following descriptions refer to an individual processing resource and an individual machine-readable storage medium, the descriptions can also apply to a system with multiple processing resources and multiple machine-readable storage mediums. In such examples, the instructions can be distributed across multiple machine-readable storage mediums and the processing resources can be distributed across multiple processing resources. Put another way, the instructions can be stored across multiple machine-readable storage mediums and executed across multiple processing resources, such as in a distributed or virtual computing environment.

As illustrated in FIG. 2, the system 208 can comprise a processing resource 210, and a memory resource 212 storing machine-readable instructions 216, 218, 219, 220 to cause the processing resource 210 to perform an operation relating to perpetual UAV surveillance. That is, using the processing resource 210 and the memory resource 212, the system 208 to perform perpetual UAV surveillance, as detailed herein. In some examples, some or all of the instructions can be stored in a memory resource included in a UAV and/or can be executed by a processing resource included in a UAV

At 216, the system 208 include instructions to position a first UAV at a first vantage point having a first field of view, as detailed herein. At 218, the system 208 can include instructions to cause a second UAV to move towards the first vantage point, as detailed herein. As used herein, “cause” or “causing” refers to directly causing an action (asserting/de-asserting a signal sent from a remote control of a UAV to the UAV) or performing an action such as sending instructions to another component to cause the action.

At 219, the system 208 can include instructions to cause the first UAV to move towards a second vantage point having a second field of view, as detailed herein. At 220, the system can include instructions to position the second UAV at the first vantage point to perpetually surveille the first field of view, as detailed herein. For instance, the second UAV can be positioned at the first vantage point responsive to the first UAV moving towards the second vantage point, among other possibilities as detailed herein.

In some examples, the system 208 can include instructions to charge a battery of the first UAV and/or the second UAV. As mentioned, a battery of a UAV can be charged while the UAV is docked at a UAV docking station or different location such as a different UAV docking station, among other possible locations. For instance, in some examples, the system 208 can include instructions to charge a battery of the first UAV, and responsive to a battery level of the first UAV reaching a threshold battery level cause the first UAV to move toward the first vantage point. That is, while FIG. 1A, 1B, 1C illustrate the first UAV 102 and the second UAV 106 moving between the first vantage point 104 and the second vantage point 107, however it is understood that the movement can be repeated to cyclically move the first UAV 102 and the second UAV 106 between the first vantage point 104 and the second vantage point 107. Such movement can be employed for any total number of UAVs and any total number of vantage points so long as at least one vantage point include a docking station with charging capabilities.

Processing resource 210 can be a central processing unit (CPU), microprocessor, and/or other hardware device suitable for retrieval and execution of instructions stored in memory resource 212. Memory resource 212 can be a machine-readable storage medium can be any electronic, magnetic, optical, or other physical storage device that stores executable instructions. Thus, machine-readable storage medium can be, for example, Random Access Memory (RAM), an Electrically-Erasable Programmable Read-Only Memory (EEPROM), a storage drive, an optical disc, and the like. The executable instructions can be “installed” on the system illustrated in FIG. 2. Machine-readable storage medium can be a portable, external or remote storage medium, for example, that allows the system 208 to download the instructions from the portable/external/remote storage medium. In this situation, the executable instructions can be part of an “installation package”, for instance to a UAV including a portion (or all) of the system 208. As described herein, machine-readable storage medium can be encoded with executable instructions related to perpetual UAV surveillance.

FIG. 3 is another example of a system including a UAV docking station 311 for perpetual UAV surveillance consistent with the disclosure. As illustrated in FIG. 3, the UAV docking station 311 can include a wireless repeater 340, a power source 342, and a data connection 344.

As used herein, a “wireless repeater” refers to device to extend a wireless local area network (WLAN) signal such as wireless signal provided by an access point 346. Though, in some examples the docking station 311 can include an access point. As used herein, an “access point” refers to receiving points for any known or convenient wireless access technology which can later become known. Specifically, the term AP is not intended to be limited to IEEE 802.11-based APs. APs function as an electronic device that is adapted to allow wireless devices to connect to a wired network via various communications standards.

The power source 342 can refer to any wired or wireless form of power transmission. For instance, in some examples, the power source 342 can include an inductive power source to wireless transfer power to a UAV such as UAV 328 (e.g., UAV 102 and/or 106 as described with respect to FIGS. 1A, 1B, 1C). That is, the power source 342 can provide power to a first UAV, a second UAV, or a combination of the first UAV and the second UAV, among other possibilities.

The data connection (represented by antennae 344) can include a wired and/or wireless connection such as those described herein. In some examples, the data connection 344 can be facilitated by an antennae which is to transmit and/or receive information. As used herein, the term “antenna” refers to a device that converts electric power into radio waves, and/or vice versa. The data connection 344 can communicate data with first UAV, the second UAV, or a combination of the first UAV and the second UAV, among other possibilities.

The UAV docking station 311 can be connected in a wired or wireless manner (e.g., via access point 346) with a remotely located computing device 348. The remotely located computing device 348 can include a database and/or other memory resource, a processing resource, a user interface or other input/output devices to permit interaction with a user, central controller for control of UAVs, and/or other equipment to promote aspects of perpetual UAV surveillance.

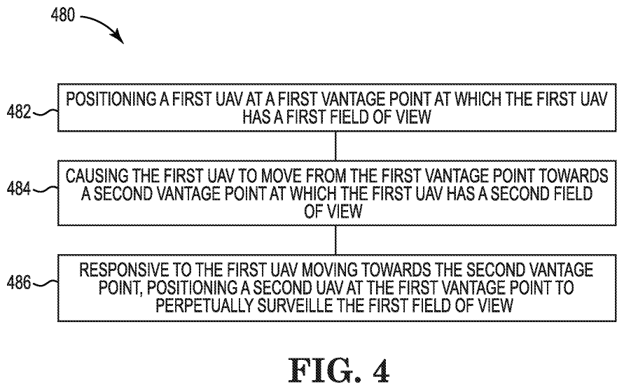

FIG. 4 illustrates an example of a method 480 consistent with the disclosure. Method 480 can be performed by a UAV such as those described herein with respect to FIGS. 1A, 1B, 1C, 2 and/or 3 and/or a different device such as the UAV docking station and/or the remotely located computing device described with respect to FIG. 3.

At 482, the method 480 can include positioning a first UAV at a first vantage point at which the first UAV has a first field of view, as described herein. At 484, the method 480 can causing the first UAV to move from the first vantage point towards a second vantage point at which the first UAV has a second field of view, as describe herein.

At 486, the method 480 can include positioning a second UAV at the first vantage point to perpetually surveille the first field of view, as describe herein. For instance, the method can include positioning a second UAV at the first vantage point to perpetually surveille the first field of view responsive to the first UAV moving towards the second vantage point.

Method 480 can be repeated. In some examples, method 480 can be repeated periodically, upon request such as request from a user, and/or responsive to a change in a condition such as a first UAV and/or a second UAV reaching a threshold or base battery level.

In the foregoing detailed description of the disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the disclosure.

The figures herein follow a numbering convention in which the first digit corresponds to the drawing figure number and the remaining digits identify an element or component in the drawing. Similar elements or components between different figures can be identified by the use of similar digits. Elements shown in the various figures herein can be added, exchanged, and/or eliminated so as to provide a plurality of additional examples of the disclosure. In addition, the proportion and the relative scale of the elements provided in the figures are intended to illustrate the examples of the disclosure and should not be taken in a limiting sense. Further, as used herein, “a plurality of” an element and/or feature can refer to more than one of such elements and/or features.

What is claimed:

1. A method of perpetual unmanned aerial vehicle (UAV) surveillance comprising:
positioning a first UAV at a first vantage point at which the first UAV has a first field of view;
causing the first UAV to move from the first vantage point towards a second vantage point at which the first UAV has a second field of view; and
while the first UAV moving towards the second vantage point, positioning a second UAV at the first vantage point to perpetually surveille the first field of view.

2. The method of claim 1, wherein the first vantage point is an aerial location at which the first UAV is airborne.

3. The method of claim 1, wherein the first UAV is docked in a UAV docking station when at the second vantage point.

4. The method of claim 1, wherein the first UAV is at a surface location when at the first vantage point, wherein the surface location further comprises a UAV docking station and wherein first UAV is docked in the UAV docking station when at the first vantage point.

5. The method of claim 1, wherein the first UAV is at an aerial location when at the second vantage point.

6. The method of claim 1, further comprising causing the first UAV to move towards the second vantage point responsive to a battery level of the first UAV reaching a base battery level.

7. The method of claim 1, further comprising causing the first UAV to move towards the second vantage point responsive to a battery level of the second UAV reaching a threshold battery level.

9. The method of claim 1, further comprising causing the first UAV to move toward the second vantage point responsive to a predetermined period of time elapsing at the first vantage point.

10. The method of claim 1, further comprising causing the first UAV to move toward the second vantage point responsive to a user input.

11. The method of claim 1, further comprising causing the first UAV to:
move towards the first vantage point; and
responsive to the second UAV moving away from the first vantage point, resume position at the first vantage point.

12. The method of claim 1, further comprising instructions to charge a battery of the first UAV, and responsive to a battery level of the first UAV reaching a threshold battery level cause the first UAV to move toward the first vantage point.

13. A non-transitory storage medium comprising instructions executable by a processing resource to:
position a first unmanned aerial vehicle (UAV) at a first vantage point having a first field of view;
cause a second UAV to move towards the first vantage point;
cause the first UAV to move towards a second vantage point having a second field of view; and
responsive to the first UAV moving towards the second vantage point, position the second UAV at the first vantage point to perpetually surveille the first field of view.

14. The medium of claim 13, further comprising instruction to position the first UAV at the first vantage point responsive to:
a user input; or
a preprogrammed flight schedule of the first UAV.

15. A system comprising:
a first unmanned aerial vehicle (UAV);
a second UAV;
a processing resource; and
a memory resource storing instructions executable by the processing resource to:
position a first unmanned aerial vehicle (UAV) at a first vantage point at which the first UAV has a first vantage point;
cause a second UAV to move towards the first vantage point;
responsive to movement of the second UAV towards the first vantage point, cause the first UAV to move towards a second vantage point; and
responsive to the first UAV moving towards the second vantage point, positioning the second UAV at the first vantage point to perpetually surveille the first field of view.

16. The system of claim 15, wherein the first vantage point, the second vantage point, or both the first vantage point and the second vantage point are a static location.

17. The system of claim 15, wherein the first vantage point, the second vantage point, or both the first vantage point and the second vantage point further comprises a plurality of locations together forming a flight path.

18. The system of claim 15, wherein the first vantage point or the second vantage point is at a UAV docking station.

19. The system of claim 18, wherein the UAV docking station includes:
a power source to provide power to the first UAV, the second UAV, or a combination of the first UAV and the second UAV; and
a data connection to communicate data with first UAV, the second UAV, or a combination of the first UAV and the second UAV.

20. The system of claim 18, wherein the UAV docking station includes a Wi-Fi repeater or an access point.
